(19) United States
(12) Patent Application Publication
(10) Pub. No.: US 2025/0224628 A1
(43) Pub. Date: Jul. 10, 2025

(54) THERMAL OPTICAL PHASE SHIFTER WITH PARTIAL SUSPENDED STRUCTURE

(71) Applicant: ADVANCED MICRO FOUNDRY PTE. LTD., Singapore (SG)

(72) Inventors: Feng GAO, Singapore (SG); Wu XIE, Singapore (SG); Xianshu LUO, Singapore (SG)

(73) Assignee: ADVANCED MICRO FOUNDRY PTE. LTD., Singapore (SG)

(21) Appl. No.: 18/852,627

(22) PCT Filed: Apr. 13, 2022
(86) PCT No.: PCT/SG2022/050219

§ 371 Date: Sep. 30, 2024

(51) Int. Cl. G02F 1/01

(52) U.S. Cl. CPC G02F 1/0147

(57) ABSTRACT

Disclosed embodiments relate to a thermal optical phase shifter and a method for adjusting speed and efficiency of intensity modulation using the thermal optical phase shifters. The thermal optical phase shifters comprise a substrate defining at least one trench within a portion of the substrate and a Buried Oxide (BOX) layer formed above the substrate. The BOX layer is disposed along a length of the substrate. The thermal optical phase shifter comprises a waveguide disposed over the BOX layer to guide an input signal, and the substrate extends partially outwards on opposite sides of the waveguide. The method comprises receiving the input signal by the thermal optical phase shifter, adjusting a voltage applied to a heater of the thermal optical phase shifter and transmitting an output signal from the thermal optical phase shifter.

### FIELD OF THE INVENTION

The invention relates generally to thermo-optical phase shifters with a suspended structure. Thermo-optical phase shifters of present invention balances efficiency and speed to fit for different application requirement. These thermo-optical phase shifters can be used in all field of photonics devices and integrated circuits which involves phase shifting or modulation, including but not limit to silicon photonics, Near/Mid IR, Visible light and microwave photonics. Particularly, these phase shifters can be used as a key component for different applications, such as quantum computing, Lidar and sensor etc., for improved speed, better thermal insulation and improved power efficiency. This invention also relates to a method for adjusting speed and efficiency of intensity modulation.

### BACKGROUND OF THE INVENTION

Generally, thermal optical phase shifters are used for phase modulation or intensity modulation of optical signals. The thermal optical phase shifters vary phase and intensity of an input optical signal based on characteristics of the input optical signal and the thermal optical phase shifters and transmit an output optical signal. A thermal optical phase shifter typically has low loss, simple fabrication, and power efficiency and finds application in a wide variety of fields, such as quantum computing, Optical Parametric Amplifier (OPA), various sensor and switching applications, advance communications and neural networks.

The thermal optical phase shifter has a composite body having an optical waveguide, a p-type region and a n-type region formed on a silicon substrate. The optical waveguide is disposed between the p-type region and the n-type region. In addition, the thermal optical phase shifter has a heater, a core comprising the silicon substrate, and a cladding layer disposed on top of the silicon substrate.

In operating the thermal optical phase shifter, the overall performance of the thermal optical phase shifter mainly depends on two key characteristics, electrical power efficiency and limiting rise/fall time constant. These two characteristics depend on heat dissipation of the thermal optical phase shifter and differ based on a change in the heat dissipation of the thermal optical phase shifter.

Existing thermal optical phase shifters are mainly of two types as illustrated in FIGS. 1A and 1B. FIG. 1A shows a first type of thermal optical phase shifter that is commonly used for different applications. The first type of thermal optical phase shifter has a substrate 102, a Buried Oxide (BOX) layer 104, a waveguide 106, a heater 108 and a cladding 110. A suspended area is disposed along the complete structure in FIG. 1B The thermal optical phase shifter of FIG. 1B has small power consumption with low efficiency and high speed. FIG. 1B shows a second type of thermal optical phase shifter having a trench 112 in the substrate 114. The second type of thermal optical phase shifter also has a BOX layer 116, a waveguide 118, a heater 120 and a cladding 122. The second type of thermal optical phase shifter of FIG. 1B has high efficiency and low speed.

The second type of thermal optical phase shifter, as shown in FIG. 1B, provides improved power efficiency, whereas the first type of thermal optical phase shifter, shown in FIG. 1A provides improved speed during operation. The second type of thermal optical phase shifter has reduced power efficiency and the first type of thermal optical phase shifter has lower speed during operation. However, none of the existing thermal optical phase shifters provide the combined advantage of improved speed, better thermal insulation and improved power efficiency during operation in one thermal optical phase shifter.

Therefore, there is a need to provide a thermal optical phase shifter which solves the above problem and provides a combined advantage of improved speed, better thermal insulation and improved power efficiency during operation.

### SUMMARY OF THE INVENTION

Embodiments of the present disclosure relate to thermal optical phase shifters and methods to use the thermal optical phase shifters to receive an input signal and transmit an output signal. In an example embodiment, the thermal optical phase shifter comprises a substrate defining at least one trench, and each of the trenches has the same length. Further, the thermal optical phase shifter comprises a Buried Oxide (BOX) layer formed above the substrate and disposed along a length of the substrate. The thermal optical phase shifter further comprises a waveguide disposed over the BOX layer to guide an input signal, wherein the substrate defining the trenches extends partially outwards on opposite sides of the waveguide.

In an example embodiment, each of the plurality of trenches has a depth of 120 micrometer (μm).

In some embodiments, the substrate extends along a lateral axis of the waveguide.

In some embodiments, the thermal optical phase shifter comprises a heater positioned adjacent to the waveguide. The heater is to heat the waveguide.

In an example embodiment, the thermal optical phase shifter comprises a cladding layer disposed along a length of the heater to cover the thermal optical phase shifter. The cladding layer protects the thermal optical phase shifter and is configured to isolate light between the heater and the waveguide.

In some embodiments, each of the trenches has a different duty cycle.

In an example embodiment, the thermal optical phase shifter has the substrate made of silicon. The substrate performs heat dissipation.

In other embodiments a thermal optical phase shifter comprises a substrate defining a trench within a portion of the substrate, wherein the trench has a predefined length, a BOX layer formed above the substrate, the BOX layer being disposed along a length of the substrate to cover the trench. The thermal optical phase shifter comprises a waveguide disposed over the BOX layer to guide an input signal, wherein the substrate extends partially outwards on opposite sides of the waveguide.

In other embodiments, the trench has a predefined period of 120 micrometer (μm).

In some embodiments, the thermal optical phase shifter comprises a heater positioned adjacent to the waveguide. The heater is configured to heat the waveguide.

In other embodiments, the heater comprises multiple heater elements disposed adjacent to the waveguide.

In an example embodiment, a cladding layer is disposed along a length of the heater to cover the thermal optical phase shifter and protect the thermal optical phase shifter. The cladding layer is configured to isolate light between the heater and the waveguide.

In an example embodiment, the BOX layer is made of silica to prevent leakage of light into the substrate.

In some embodiments, the substrate is made of silicon, and the substrate performs heat dissipation.

In some embodiments, a method for adjusting speed and efficiency of intensity modulation is disclosed. The method comprises receiving by a thermal optical phase shifter, an input signal. The input signal is an optical signal. The thermal optical phase shifter comprises a substrate defining at least one trench, a BOX layer formed above the substrate and a waveguide disposed over the BOX layer. The substrate extends partially outwards on opposite sides of the waveguide. The method comprises adjusting a voltage applied to a heater of the thermal optical phase shifter. The thermal optical phase shifter transmits an output signal. The output signal has a different phase than the input signal and the difference in phase is based on a change in the voltage applied.

Thermal optical phase shifters of the disclosure provide a combined advantage of improved speed, better thermal insulation and improved power efficiency during operation in one thermal optical phase shifter. These phase shifters can be used as a key component for different applications, such as quantum computing, Lidar and sensor etc.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIGS. 1A and 1B are prior art illustrating existing types of thermal optical phase shifters;

FIGS. 2A and 2B are exemplary views illustrating an optical thermal phase shifter in accordance with a first embodiment of the present disclosure;

FIGS. 3A and 3B are exemplary views illustrating an optical thermal phase shifter in accordance with a second embodiment of the present disclosure;

FIG. 4 is a graphical representation illustrating power efficiency of thermal optical phase shifters according to a length of a heater; and

FIG. 5 is an example flow diagram illustrating a method for adjusting speed and efficiency of intensity modulation using a thermal optical phase shifter.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The use of the term “comprising” and the term “including”, (as well as other forms such as “comprises”, “includes”, and “included”) is not to be interpreted as limiting.

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment).

Use of the term “exemplary” or an “example” is understood to refer to a non-exclusive example, and the use of such term means “serving as an example, instance, or illustration,” and should not necessarily be construed as preferred or advantageous over other embodiments.

The terms “about” or approximately” or the like, when used with a number, is understood to mean that specific number, or alternatively, a range in proximity to the specific number, as understood by persons of skill in the art field.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

In the following description, reference is made to the accompanying drawings that form a part hereof, and in which is shown by way of illustration specific embodiments which may be practiced. These embodiments are described in sufficient detail to enable those skilled in the art to practice the present disclosure, and it is to be understood that other embodiments may be utilized and that structural, logical and electrical changes may be made without departing from the scope of the present disclosure. The following description of example embodiments is, therefore, not to be taken in a limited sense.

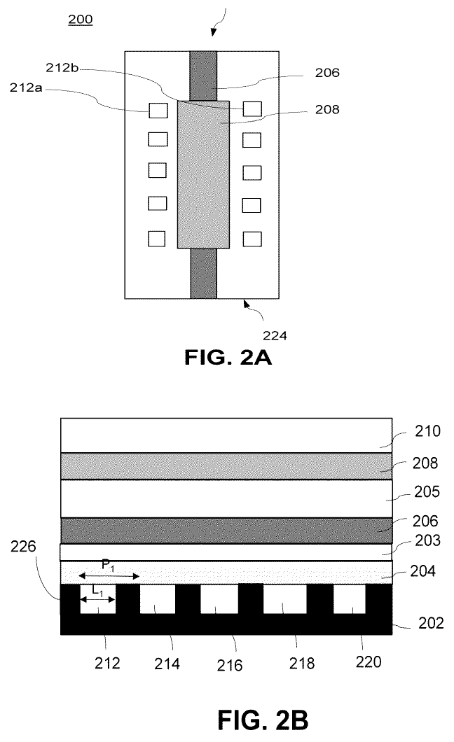

FIGS. 2A and 2B illustrate various views of the thermal optical phase shifter 200 in accordance with a first embodiment of the present disclosure. FIG. 2A illustrates a top view and FIG. 2B illustrates a sectional view of the thermal optical phase shifter 200.

The thermal optical phase shifter 200 has a substrate 202, a Buried Oxide (BOX) layer 204, and a waveguide 206. Further, the thermal optical phase shifter 200 comprises a heater 208 and a cladding layer 210. The substrate 202 has multiple trenches, such as trenches 212, 214, 216, 218, and 220 as shown in FIG. 2B.

In this regard, the trenches 212, 214, 216, 218, and 220 are comprised within the substrate layer and comprise holes or spaces between substrate pillar structures 226 that contact with the BOX layer 204. The trenches 212, 214, 216, 218, and 220 are formed such that the layers on top and above the substrate layer are suspended via said pillar structures 226. Such a structural configuration can be termed as a suspended structure, as referenced herein. The suspended structure is to suspend the optical waveguide 206, BOX 204, cladding layer 210 through partial etching of silicon (Si) substrate.

An oxide layer 205 separates the heater 208, and the optical waveguide 206, to reduce metal absorption. In one embodiment, the oxide layer 205 can operate as a cladding layer for the thermal phase optical shifter without the heater 208. In addition, the oxide layer 205 operates to isolate light.

In an example, the substrate 202 is made of silicon. In another example, the substrate 202 is formed of glass material containing quartz or silica. As shown in FIG. 2B, the substrate 202 comprises multiple trenches 212, 214, 216, 218, and 220. Although, the FIG. 2B illustrates the substrate 202 having five trenches 212, 214, 216, 218, and 220, there may be more than five trenches within the substrate 202 in some embodiments. In FIG. 2B, there are 5 trenches, however it will be appreciated that the number of trenches could be less than 5 and greater than 2. Each length (L) of the trench can be less than 80 μm. The number of trenches can be dependent upon the total length of each structure. The trenches can be formed by etching.

Each of the multiple trenches 212, 214, 216, 218, and 220 can have same length L₁ and period P₁ and each trench 212, 214, 216, 218, and 220 is disposed at a uniform distance from an adjacent trench in the substrate 202. In an example, the length L₁ and period P₁ are arbitrary values based on structure of the trenches. In an example, the trenches are obtained by etching the silicon substrate partially below an optical waveguide through isotropic etching process. The optical waveguide is suspended in the air with small bridge to hold the structure and prevent collapse.

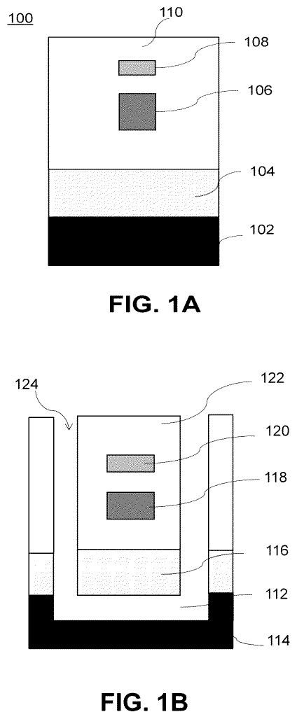

In an example, the substrate 202 is disposed such that the substrate 202 extends outwardly, for instance, on opposite sides of the waveguide 206 along a lateral axis of the thermal optical phase shifter 200. The substrate 202, the waveguide 206 and the heater 208 are aligned such that the trenches 212, 214, 216, 218 remain uncovered by the waveguide 206 and the heater 208 that are formed on the substrate 202. In an example, the trenches 212, 214, 216, 218, and 220 isolate heat dissipation. As optical waveguide with heater is suspended in the air, there is no connection with the silicon substrate. Therefore, the trenches isolate heat dissipation to silicon substrate. In comparison, FIG. 1A and FIG. 1B consists of the structure 112 with the trench 124, at the side of the waveguide, whereby air in structure 112 could prevent heat dissipation into silicon substrate.

In one embodiment, each trench comprises two holes or spaces on each side of the waveguide 206, as shown in FIG. 2A For example, the trench 212 comprises two holes 212a and 212b. The depth of each of the two holes from top of the cladding layer 210 to the substrate 202 can be 120 micrometre (μm). The holes themselves form the trenches.

In one embodiment, the BOX layer 204 can be made of silica or Silicon Dioxide (SiO₂). The BOX layer 204 is sandwiched between a thicker silicon substrate, such as the substrate 202, and a top silicon layer 203, whereby the BOX layer 204 acts as an insulation layer. The BOX layer 204 has two opposing surfaces, an upper surface and a lower surface. In an example implementation, the top silicon layer 203 is in contact with the upper surface of the BOX layer 204 and the substrate 202 is in contact with the lower surface of the BOX layer 204 via the substrate pillars 226. During operation of the thermal optical phase shifter 200, the BOX layer 204 prevents leakage of light into the substrate 202. The BOX layer 204 is thick, for instance greater than 2 micrometers to prevent light coupling into substrate. This provides an advantage of reducing optical loss.

The waveguide 206 is formed above the BOX layer 204 and is made of high thermal optical coefficient material having a linear refractive index, such as silicon or silicon nitride. The refractive index changes in response to a change in temperature, such that a rise in the temperature increases the refractive index and a drop in the temperature decreases the refractive index. In an example, the material for the waveguide 206 is selected such that changes in the refractive index of the waveguide 206 causes variations in the phase of a light ray traveling through the waveguide 206. The waveguide 206 may be used to couple optical signal, such as an input signal and a corresponding output signal, into and out of the thermal optical phase shifter 200.

The heater 208, in an example, is made of doped silicon or a metal, such as Titanium Nitride (TiN). The heater 208 is positioned adjacent the waveguide 206 and extends along the length of the waveguide 206. In an example, the heater 208 is a single heating element extending along the length of the waveguide 206 or multiple heating elements distributed and arranged around the waveguide 206. The purpose of arranging the heater 208 is to provide direct and efficient heating to the waveguide 206 and rapidly increase the refractive index of the waveguide 206.

The heater 208 generates the heat based on a voltage applied by a power source. The power source is electrically connected with the heater 208 through a pair of electrodes. In an instance, when the heater 208 is to be heated, the power source applies the voltage to the heater 208 and the heater generates the heat. The amount of heat generated depends on a change in the voltage applied to the heater 208. In an example, the heater 208 supplies a large amount of heat to the waveguide 206 and causes a rapid increase in the temperature of the waveguide 206. For example, when the heater 208 is made of Titanium Nitride (TiN), Titanium (Ti) or any other material, the heater 208 supplies heat when electricity is applied. When the waveguide 206 is heated, the refractive index of the waveguide 206 varies based on the temperature response of the waveguide 206. The change in the refractive index causes a change in phase and intensity of the signal passing through the waveguide 206 to transmit as the output signal.

In one embodiment of the present disclosure, the cladding layer 210 is made of an insulator material, such as silicon dioxide (SiO₂). The cladding layer 210 is disposed on top of the heater 208. The cladding layer 210 protects the thermal optical phase shifter 200 and isolates light between the heater 208 and the waveguide 206.

The thermal optical phase shifter 200, as shown in FIGS. 2A and 2B, is of a rectangular shape. The thermal optical phase shifter 200 is configured to receive the input signal on one end 222 of the thermal optical phase shifter 200 and transmit the output signal on the other end 224 of the thermal optical phase shifter 200. In an example, the input signal and the output signal are light waves or optical waves that are received by the thermal optical phase shifter 200 and propagated through the thermal optical phase shifter 200. In an instance, when there is no phase shifting performed by the thermal optical phase shifter 200, the input signal and the output signal are colinear with each other along a primary axis of thermal optical phase shifter 200. In other words, when the input signal enters the thermal optical phase shifter 200 from the end 222 and the output signal transmits from the other end 224, the input signal and the output signal are substantially along the same line. In an example, the output signal has same amplitude and frequency as the input signal. The optical phase shifter 200 has a suspended area partially disposed with different ratio to balance power consumption and speed. In FIG. 2B, there is no duty cycle and only one parameter is the length of suspended part. When length is longer, speed degrades and efficiency improves. When length is smaller, speed improves and efficiency degrades.

During operation when a phase shift is introduced by thermal optical phase shifter 200, the power source applies a voltage to the heater 208 and the heater 208 heats the waveguide 206 as described previously. The heating of the waveguide 206 causes a change in the refractive index thereby causing the change in phase of the input signal. When the input signal propagates through the thermal optical phase shifter 200, the trenches 212, 214, 216, 218, and 220 of the substrates 202 provide different duty cycles thereby providing improved efficiency and speed of intensity modulation. The output signal transmits from the thermal optical phase shifter 200 with a phase difference with respect to the input signal. The magnitude of the phase difference is based on the amount of voltage applied to thermal optical phase shifter 200. A higher voltage applied to the thermal optical phase shifter 200 causes higher temperature of the heater 208 and an increased phase shift in the output signal. The trenches 212, 214, 216, 218, and 220 allow adjusting of the efficiency and speed of intensity modulation by the thermal optical phase shifter 200.

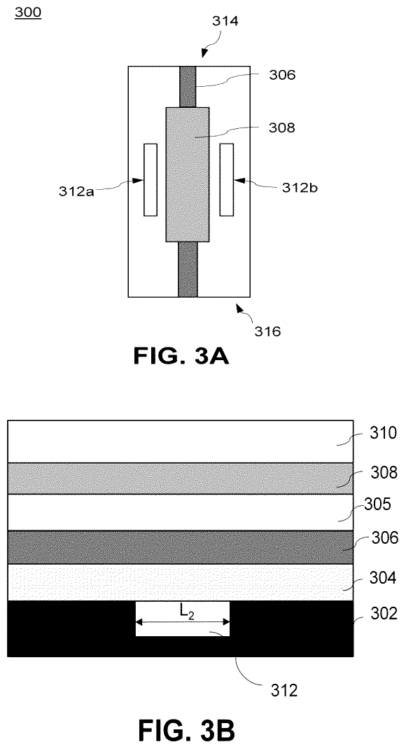

FIGS. 3A and 3B illustrate various views of the thermal optical phase shifter 300, in accordance with a second embodiment of the present disclosure. FIG. 3A illustrates a top view and FIG. 3B illustrates a sectional view of the thermal optical phase shifter 300.

The thermal optical phase shifter 300 has a substrate 302, a Buried Oxide (BOX) layer 304, an oxide layer 305 and a waveguide 306. The thermal optical phase shifter 300 comprises a heater 308 and a cladding layer 310. The substrate 302 has single trench 312 as shown in FIG. 3B. The trench 312 is disposed within a portion of the substrate 302, for instance, within a central region of the substrate 302.

The substrate 302 is made of silicon or glass material containing quartz. In an implementation, the trench 312 has a predefined length L₂ and has two holes on each side of the waveguide 306. The depth of each of the two holes from top of the cladding layer 310 to the substrate 302 is 120 μm. In an example, the substrate 302 defining the trench 312 extends outwardly on opposite sides of the waveguide 306 along a lateral axis of the thermal optical phase shifter 300. The substrate 302, the waveguide 306 and the heater 308 are aligned such that the trench 312 remains uncovered by the waveguide 306 and the heater 308.

In one embodiment, the trench 312 comprises two holes on each side of the waveguide 306, as shown in FIG. 3A For example, the trench 312 comprises two holes 312a and 312b. The depth of each of the two holes from top of the cladding layer 310 to the substrate 302 can be 120 micrometre (μm).

In one embodiment, the BOX layer 304 is made of silica. The waveguide 306 is formed above the BOX layer 304 and is made of high thermal optical coefficient material having a linear refractive index, such as silicon or silicon nitride. The refractive index of the waveguide 306 changes in response to a change in the temperature. The heater 308 is positioned adjacent the waveguide 306 and extends along the length of the waveguide 306. The heater 308, in one example, has multiple heating elements distributed and arranged around the waveguide 306.

As explained with reference to FIGS. 2A and 2B, the heater 308 is similarly connected with the power source through a pair of electrodes, such that when a voltage is applied through the pair of electrodes, variations in the voltage causes variations in the temperature of the heater 308. The heater 308, in an example, is made of doped silicon or a metal, such as Titanium Nitride (TiN).

In the example embodiment, the cladding layer 310 is made of an insulator material, such as silicon dioxide (SiO₂). The cladding layer 310 protects the thermal optical phase shifter 300 and isolates light between the heater 308 and the waveguide 306.

In operation, the thermal optical phase shifter 300 receives the input signal on one end 314 of the thermal optical phase shifter 300. The phase shifting performed by the thermal optical phase shifter 300 is based on heating by the heater 308 similar to the heating by the heater 208, as explained previously with reference to operation of the thermal optical phase shifter 200. When the input signal propagates through the thermal optical phase shifter 300, the trench 312 provides different duty cycle and provides improved efficiency and speed of intensity modulation. The output signal then transmits from the other end 316 of the thermal optical phase shifter 300. The output signal has a phase difference with respect to the input signal.

In an example, the magnitude of the phase difference is based on the voltage applied to thermal optical phase shifter 300. The trench 312 provides different duty cycle and provides relevant efficiency and speed in phase modulation thus the efficiency and speed can be adjusted.

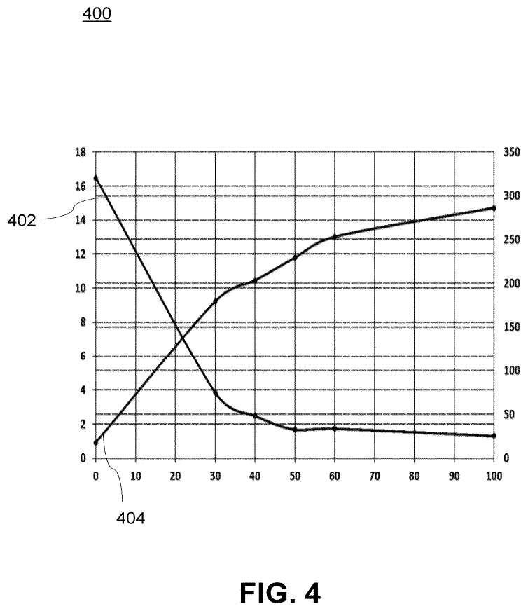

The adjustment in the speed and efficiency is shown in graph 400 of FIG. 4. FIG. 4 illustrates testing results with different duty and suspended length or whole heater length. The graph 400 shows power efficiency plotted on y-axis and the length of heater plotted on x-axis against time. The lines 402 and 404 shows the experiment results of the thermal optical phase shifter 200 of FIGS. 2A and 2B. The graph 400 shows measured results of limiting rise time constant or speed and electrical power efficiency at different ratio of suspended heater length to whole heater length. In FIG. 4, when the duty is 100%, the structure has a whole suspended heater with low power consumption but slow speed of FIG. 1B, and when the duty is 0%, the structure is without a suspended heater, with high power consumption and fast speed of FIG. 1A The experimental results are comparable for both the embodiments of FIGS. 2A-B and FIGS. 3A-B.

In an example, a 2×2 thermo-optic waveguide-based switch with ultralow power consumption is fabricated using a standard complementary metal-oxide-semi conductor (CMOS) process. Phase arms are suspended by removing adjacent SiO₂ and 120 micrometers of the underlying Si, while leaving a few SiO₂ beams to support the suspended phase arms for the purpose of structural strength. When compared with a switch without isolation layer, a significant reduction of greater than 98% in power consumption is achieved. The reduction in power consumption is realized by preventing the heat from leaking out of the phase arms due to the presence of the air isolation layer. The thermal optical phase shifter, as per invention shows an extinction ratio of over 23 dB at 1550 nm for TE mode with an ultralow power consumption of 0.49 milliwatt (mW), and the response time is 266 microseconds, including the raise time of 144 microseconds and the fall time of 122 microseconds.

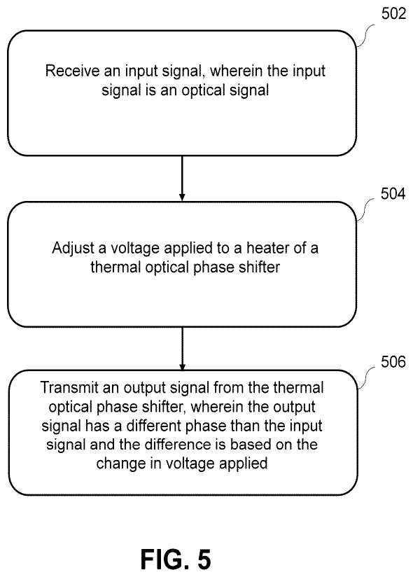

The operation of the thermal optical phase shifters 200 and 300 are described in conjunction with FIG. 5.

Referring to FIG. 5, in conjunction with FIGS. 2A and 2B, and FIGS. 3A and 3B, a method flow diagram 500 illustrating adjusting speed and efficiency of intensity modulation, by a thermal optical phase shifter, such as the thermal phase optical shifters 200 and 300 is described.

Turning first to block 502, an input signal is received. The input signal is an optical signal, an optical wave, or an incident light ray. In an example, the input signal is received by the thermal optical phase shifter, such as the thermal optical phase shifters 200 and 300. The thermal optical phase shifter comprises a substrate defining at least one trench, a BOX layer formed above the substrate and a waveguide disposed over the BOX layer, and a heater. The substrate extends partially outwards on opposite sides of the waveguide.

The heater is disposed adjacent the waveguide such that the heater provides direct heating to the waveguide. In an example, the heater is connected to a power source through a pair of electrodes or wires. The power source is used to apply a voltage to the heater to produce heat. At block 504, the voltage applied to the heater of the thermal optical phase shifter is adjusted. The voltage is adjusted to control the amount of heat generated by the heater. The amount of heat generated by the heater causes the waveguide to vary the refractive index. The waveguide modulates the phase of the input signal based on the variation in the refractive index of the waveguide to transmit an output signal.

Thereafter, at block 506, the output signal is transmitted from the thermal optical phase shifter. In an example, the phase of the output signal is different from the phase of the input signal, and the difference in the phase is based on the change in the voltage applied. For instance, a higher voltage causes a phase difference between the input signal and the output signal to increase, and a decrease in the voltage applied causes the phase difference to decrease. The substrate having the at least one trench causes a difference in duty cycles and allows balance between the speed and power efficiency of the thermal optical phase shifter.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments but shall not limit the application of such issued claims to processes and structures accomplishing any or all of the above advantages or having any or all of the above features.

Having described the various systems and methods herein, various embodiments of the systems and methods can include, but are not limited to the claims provided herein.

1. A thermal optical phase shifter comprising:
a substrate defining at least one trench;
a waveguide adapted to guide an input signal;
a top silicon layer;
a BOX layer formed between the substrate and the top silicon layer, wherein the BOX layer is an insulation layer in contact with the substrate and isolated from the waveguide by the top silicon layer; and
a heater, wherein the waveguide is positioned between the heater and the BOX layer, and the heater is adapted to heat the waveguide;
wherein the at least one trench comprises two holes positioned on each side of the waveguide.

2. The thermal optical phase shifter of claim 1, wherein the at least one trench has a depth of 120 micrometer (μm).

3. The thermal optical phase shifter of claim 1, wherein the substrate extends along a lateral axis of the waveguide, and the at least one trench is partially defined by the substrate and the BOX layer.

4. The thermal optical phase shifter of claim 1 further comprising a cladding layer, made of silicon dioxide (SiO₂).

5. The thermal optical phase shifter of claim 1 comprising a cladding layer disposed along a length of the heater, adapted to cover and protect the thermal optical phase shifter, wherein the cladding layer is configured to isolate light between the heater and the waveguide.

6. The thermal optical phase shifter of claim 1, wherein each of the at least one trench has a different length.

7. The thermal optical phase shifter of claim 1, wherein the substrate is made of silicon and the substrate is adapted to dissipate heat.

8. The thermal optical phase shifter of claim 1, wherein the at least one trench comprises five trenches.

9. The thermal optical phase shifter of claim 1, wherein the at least one trench consists of one trench.

10. A method for adjusting speed and efficiency of intensity modulation, the method comprising:
receiving, by the thermal optical phase shifter according to claim 1, an input signal, wherein the input signal is an optical signal;
adjusting a voltage applied to a heater of the thermal optical phase shifter;
transmitting an output signal from the thermal optical phase shifter, wherein the output signal has a different phase than the input signal and the difference in phase is based on a change in the voltage applied.
